(19) United States
(12) Patent Application Publication
(10) Pub. No.: US 2023/0243681 A1
(43) Pub. Date: Aug. 3, 2023

(54) THROUGHFLOW MEASUREMENT SYSTEM

(71) Applicant: SICK ENGINEERING GMBH, Ottendorf-Okrilla (DE)

(72) Inventors: Gerry SCHRÖTER, Dresden (DE); Mario KÜNZELMANN, Dresden (DE); Eric STARKE, Pirna (DE); Christian SCHULZ, Dresden (DE)

(21) Appl. No.: 18/102,271

(22) Filed: Jan. 27, 2023

(30) Foreign Application Priority Data
Feb. 1, 2022 (EP) 22154436.4

(51) Int. Cl. G01F 1/66; G01F 1/667

(52) U.S. Cl. CPC G01F 1/662; G01F 1/667

(57) ABSTRACT

A throughflow measurement system comprises a measurement body that has an inlet flange, an outlet flange and a fluid passage, wherein the fluid passage has a passage axis; an ultrasonic measurement apparatus integrated into the measurement body; and a flow conditioner arranged upstream of the ultrasonic measurement apparatus in the fluid passage. An arrangement of bores for fastening means is provided at the outlet flange, wherein an axially extending outlet fastening region of the measurement body is defined by the length of the bores. The ultrasonic measurement apparatus has at least one reflection measurement path that is spanned by a first ultrasonic transducer, a reflector and a second ultrasonic transducer and that extends in a measurement plane through the fluid passage such that the second ultrasonic transducer is arranged downstream of the first ultrasonic transducer. The second ultrasonic transducer disposed downstream is arranged in or projects into the outlet fastening region.

The present invention relates to a throughflow measurement system for measuring a fluid throughflow in a high pressure line, comprising a measurement body that has an inlet flange, an outlet flange and a fluid passage, wherein the fluid passage extends between the inlet flange and the outlet flange and has a passage axis; an ultrasonic measurement apparatus integrated into the measurement body; and a flow conditioner arranged upstream of the ultrasonic measurement apparatus in the fluid passage.

In many areas of technology, measurements are to be performed at flowing fluids, i.e. gases or liquids. For example, flow rates of flowing fluids in pipelines or passages can be determined by means of ultrasonic measurement technology in accordance with the transit time difference method. A corresponding ultrasonic measurement apparatus and a corresponding method are, for example, described in DE 10 2016 112 295 A1. The volume flow of the fluid flowing through the pipeline can be determined on the basis of the flow rate and the cross-sectional surface of the pipeline or of the passage. Such volume flow measurement apparatus are frequently used in the form of meters to determine delivery quantities and/or consumption quantities of gases or liquids.

In such measurements, a flow profile that is as uniform as possible is generally desired to ensure a high measurement accuracy. In practice, however, inhomogeneous or disturbed flow profiles are often present. They can be conditioned in the direction of undisturbed flows again by a flow conditioner. Known flow conditioners can have plates, sheet metals, grids, inner tubes and the like.

Due to a desired exchangeability of measurement devices, a certain installation length is frequently predefined for the measurement body. A common specification is, for example, three times the nominal width of the fluid passage. Depending on its performance capability, the flow conditioner takes up a relatively large portion of the axial length of the measurement body. Furthermore, the ultrasonic measurement apparatus also has a relatively large axial length, in particular when a high measurement accuracy is required. For these reasons, it is often difficult to maintain a predefined installation length.

It is an object of the invention to specify a throughflow measurement system that is suitable for high pressure and that has a high measurement accuracy and a large tolerance with respect to disturbed flow profiles and that can nevertheless be designed with a relatively short installation length.

The object is satisfied by a throughflow measurement system having the features of claim 1.

In accordance with the invention, an arrangement of bores for fastening means is provided at the outlet flange and an axially extending outlet fastening region of the measurement body is defined by the length of the bores (preferably in particular the length of a possibly present very long bore), wherein the ultrasonic measurement apparatus has at least one reflection measurement path that is spanned by a first ultrasonic transducer, a reflector and a second ultrasonic transducer and that extends in a measurement plane through the fluid passage such that the second ultrasonic transducer is arranged downstream of the first ultrasonic transducer, wherein the second ultrasonic transducer disposed downstream is arranged in or projects into the outlet fastening region.

The provision of a reflection measurement path, i.e. a “folded” measurement path, enables the provision of a measurement path having a sufficient extent in the flow direction in a small installation space. The outlet fastening region takes up a portion of the axial length of the measurement body, wherein the bores should in particular be comparatively deep for high-pressure applications. Since the ultrasonic transducer disposed downstream is arranged in or projects into the outlet fastening region, the region provided for the bores and the region provided for the ultrasonic measurement apparatus overlap so that a reduction in the overall extent of the measurement body results. Accordingly, the flow conditioner can be designed as relatively long for a predefined total length to improve the disturbance resistance. A throughflow measurement system in accordance with the invention is thus capable of providing a relatively high measurement accuracy despite a small installation length even when disturbed flow profiles are present.

An arrangement of bores for fastening means is preferably also provided at the inlet flange. Via the flanges with the bores, the measurement body can be installed in a pressure-tight manner in a fluid conveying system or the like.

The outlet fastening region generally has a disk-like shape. The second ultrasonic transducer disposed downstream can at least partly be arranged within the outlet fastening region between two adjacent bores. Equally, a cable passage, which extends from the surface of the measurement body up to the second ultrasonic transducer disposed downstream, can at least sectionally be located between two adjacent bores.

The spanning of a reflection measurement path is in particular achieved by the orientation of the reflector that is selected such that an ultrasonic signal transmitted by the first ultrasonic transducer or by the second ultrasonic transducer is directed to the other ultrasonic transducer after a reflection at the reflector. The first ultrasonic transducer does not necessarily have to be a transmitter and the second ultrasonic transducer does not necessarily have to be a receiver. Rather, the signal direction can also be reversed or bidirectional.

The ultrasonic measurement apparatus preferably has at least two reflection measurement paths, wherein each of the reflection measurement paths is spanned by a first ultrasonic transducer, a reflector and a second ultrasonic transducer and extends in a measurement plane through the fluid passage such that the second ultrasonic transducer is arranged downstream of the first ultrasonic transducer. Particularly robust ultrasonic measurements can hereby be performed. Furthermore, the possibility of providing an emergency operation function results. If one of the reflection measurement paths fail, the device can continue to measure by means of the other reflection measurement path. The throughflow measurement system is preferably configured to output a corresponding warning signal in this case. For space reasons, provision can be made that each of the second ultrasonic transducers disposed downstream is arranged in or projects into the outlet fastening region.

In accordance with an embodiment of the invention, at least one of the measurement planes, and preferably each of the measurement planes, is tilted about a perpendicular line of the associated reflector, starting from an alignment extending in parallel with the passage axis. Due to this tilt, the measurement plane only requires a small axial installation space. Furthermore, the cross-section of the fluid passage is better covered by measurement paths.

The tilt is preferably sufficiently strong that an appreciable axial space saving results, but, on the other hand, the measurement path has a sufficient component in the flow direction. A specific embodiment of the invention provides that the tilt angle has a magnitude of at least 5° and at most 60°, preferably of at least 15° and at most 45°, and particularly preferably of at least 25° and at most 35°.

The measurement planes of the reflection measurement paths can be tilted in opposite directions, preferably by tilt angles of equal magnitude. This enables a particularly space-saving design. The perpendicular line can extend transversely to the passage axis. In other words, the perpendicular line can extend at right angles to the passage axis, but does not necessarily have to intersect it. The at least two reflection measurement paths can be designed such that the reflectors are disposed opposite one another, at least viewed in an axial sectional plane.

A further embodiment of the invention provides that the perpendicular line is arranged offset from the passage axis, viewed in a cross-sectional plane of the fluid passage. In other words, the reflection measurement path can be arranged off-center. The perpendicular lines of the reflectors of two reflection measurement paths can in particular be arranged offset from the passage axis in opposite directions, preferably by the same offset. In this way, the cross-section of the fluid passage is covered relatively uniformly by measurement paths of the ultrasonic measurement apparatus, which enables particularly accurate and robust measurements.

The measurement body preferably has a length that amounts to at most three times the diameter of the fluid passage. Such a length limitation of the measurement body enables the use of a throughflow measurement system in accordance with the invention in a wide variety of common systems. In the case of a fluid passage having a varying diameter, the diameter of the fluid passage is to be understood as the minimum diameter, the maximum diameter or the average diameter.

The flow conditioner is preferably designed with at least three stages. It has been shown that relatively strongly disturbed flow profiles are to be expected in many areas of application so that only a flow conditioner having at least three stages is capable of effecting a sufficient conditioning.

A specific embodiment of the invention provides that the flow conditioner comprises at least one hub body that is rotationally symmetrical with respect to the passage axis and that has an arched onflow region and/or that the flow conditioner comprises at least one Spearman rectifier, a honeycomb body, an inner tube and/or a perforated plate. Such flow conditioners have proven to be particularly powerful. A particularly preferred embodiment provides an arrangement comprising a hub body, a Spearman rectifier and a perforated plate as the flow conditioner. The flow conditioner can comprise at least one hub body that is designed as in the European application 20203266.0, filed on Oct. 22, 2020.

A further embodiment of the invention provides that the reflection measurement path, and preferably each reflection measurement path, has a reflection angle of at least 5° and at most 45°, preferably of at least 10° and at most 30°. It has been shown that a sufficiently easily evaluable measurement signal results at such reflection angles at a minimum axial length.

A further embodiment of the invention provides that the reflection measurement path, and preferably each reflection measurement path, is arranged completely outside a surrounding region of the passage axis, i.e. in particular does not contact the passage axis. A secant path is more favorable in a technical flow aspect than a center path. The covering of the passage cross-section can in particular be optimized.

The measurement body is preferably produced from steel and/or is formed in one piece. This ensures a particularly stable design and in particular enables the use of the throughflow measurement system in high-pressure applications.

The measurement body can in particular be adapted for a fluid pressure of at least 0.5 bar and/or at most 110 bar.

The inlet flange and/or the outlet flange can have a nominal width between 40 mm and 200 mm. In other words, it is preferred that the throughflow measurement system in accordance with the invention is suitable for small and medium nominal widths.

In accordance with a further embodiment of the invention, at least eight bores, and preferably exactly eight bores, for fastening means are provided at the outlet flange and preferably also at the inlet flange, said bores being arranged distributed around the fluid passage. This enables a connection safe for high pressure of the measurement body to a line system.

Further developments of the invention can also be seen from the dependent claims, from the description, and from the enclosed drawings.

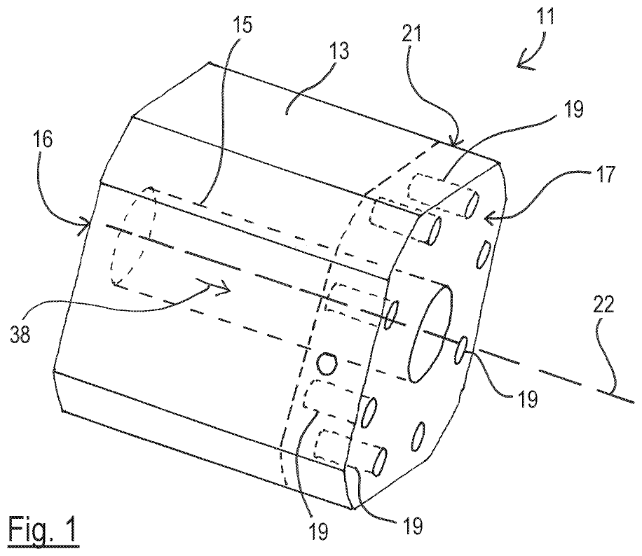

FIG. 1 shows a throughflow measurement system in accordance with the invention in a perspective view;

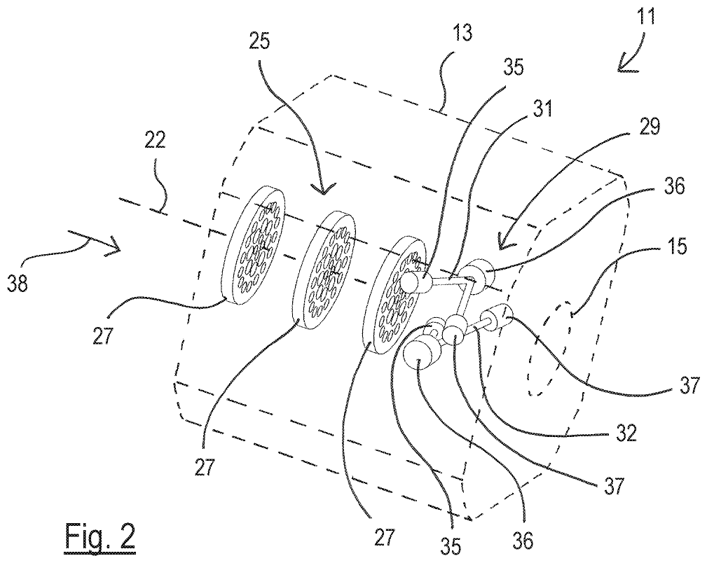

FIG. 2 shows a flow conditioner and an ultrasonic measurement apparatus of the throughflow measurement system shown in FIG. 1;

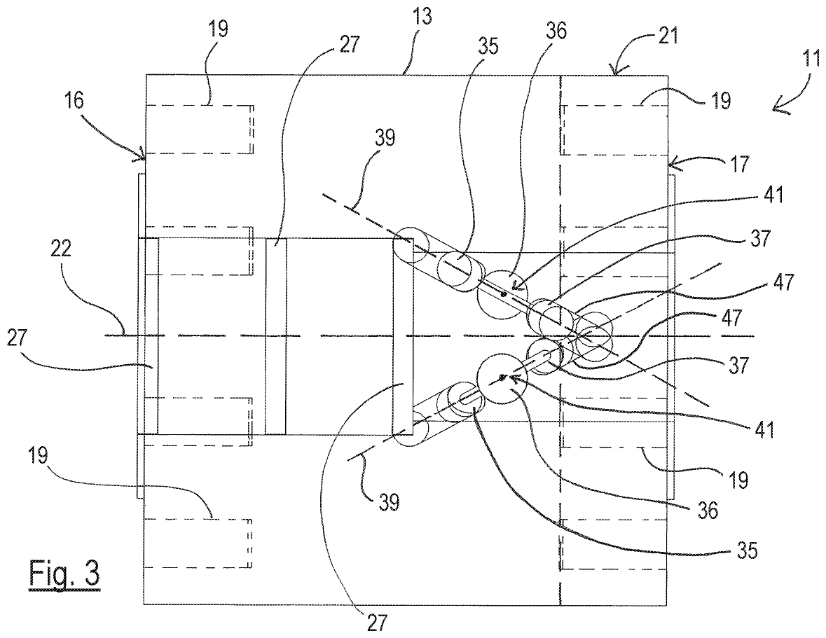

FIG. 3 is a partly broken away side view of the throughflow measurement system shown in FIG. 1;

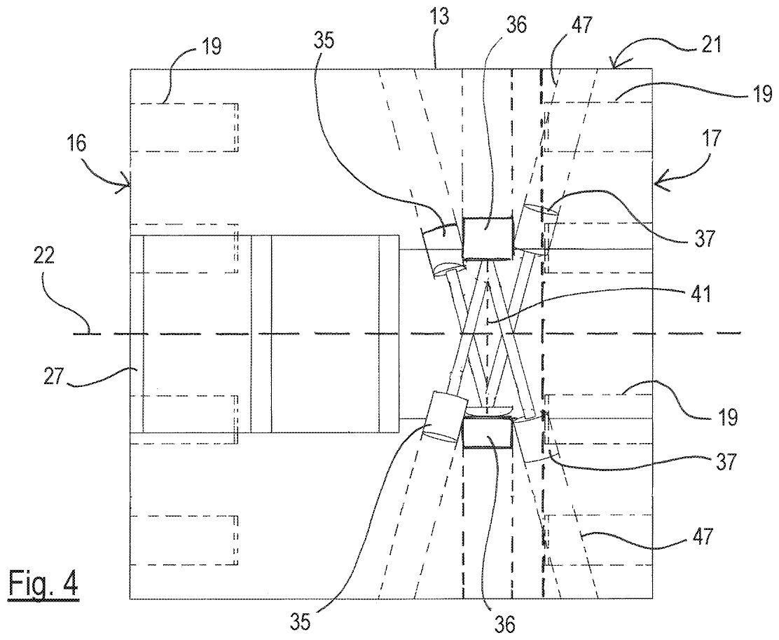

FIG. 4 is a partly broken away plan view of the throughflow measurement system shown in FIG. 1; and

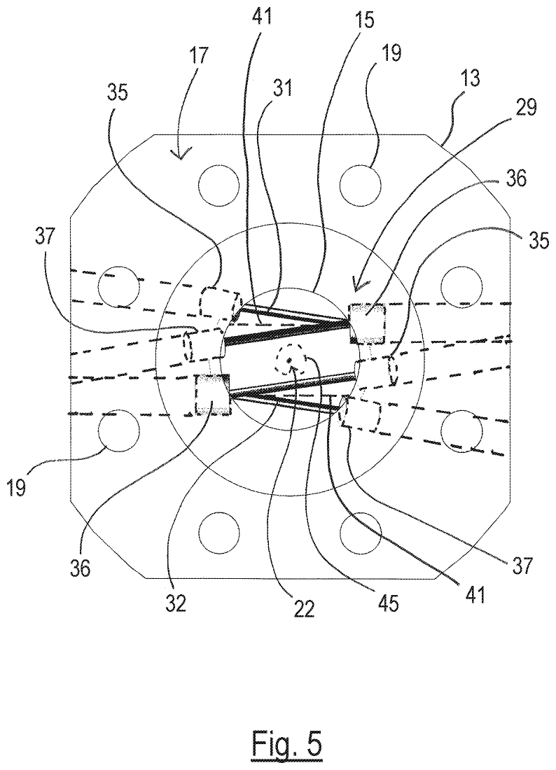

FIG. 5 is a rear view of the throughflow measurement system shown in FIG. 1.

The throughflow measurement system 11 that is shown in the Figures and that is designed in accordance with an embodiment of the invention comprises a measurement body 13 which is produced from steel, which is preferably formed in one piece and in which a fluid passage 15 is formed in the form of a central leadthrough. In the embodiment shown, the fluid passage 15 has a circular cross-section. The fluid passage 15 is rectilinear and defines a passage axis 22.

For the installation into a fluid line system, not shown, the measurement body 13 has an inlet flange 16 and an outlet flange 17. The inlet flange 16 and the outlet flange 17 can, as shown, be planar and can extend in parallel with one another. An arrangement of eight bores 19 for fastening means such as screws is provided at the outlet flange 17. An axially extending, disk-like outlet fastening region 21 of the measurement body 13 is defined by the maximum, preferably uniform length of the bores 19 provided with threads. An arrangement of eight bores 19 is also provided at the inlet flange 16, as can be seen in FIGS. 3 and 4. For better clarity, the bores provided at the inlet flange 16 were omitted in FIGS. 1 and 2.

As can be seen in FIG. 2, a flow conditioner 25 is arranged in the fluid passage 15. The flow conditioner 25 is designed with three stages, wherein three perforated plates 27 are shown by way of example as stages in FIG. 2. However, at least one stage, and preferably exactly one stage, of the flow conditioner 25 could be designed as a hub body that is rotationally symmetrical with respect to the passage axis 22 and that has an arched onflow region. Furthermore, individual stages or all the stages of the flow conditioner 25 could be designed as a Spearman rectifier, a honeycomb body or an inner tube.

Downstream of the flow conditioner 25, an ultrasonic measurement apparatus 29 is arranged in the measurement body 13. The ultrasonic measurement apparatus 29 has two reflection measurement paths 31, 32 that are each spanned by a first ultrasonic transducer 35, a reflector 36 and a second ultrasonic transducer 37. In accordance with the law of reflection, the reflection measurement paths 31, 32 extend in respective measurement planes through the fluid passage 15. In this respect, the second ultrasonic transducer 37 is in each case arranged downstream of the first ultrasonic transducer 35 with respect to a fixed flow direction 38. The first ultrasonic transducers 35 and the second ultrasonic transducers 37 are in signal connection with an electronic control device, not shown, that is configured to determine the fluid throughflow through the fluid passage 15 based on the sensor signals by means of the known transit time method while considering the Doppler effect. The first ultrasonic transducers 35 and the second ultrasonic transducers 37 can generally be transmitter/receiver combinations, that is, the reflection measurement paths 31, 32 can be provided for a bidirectional signal transmission.

So that the reflection measurement paths 31, 32 have an axial component, on the one hand, and only take up a small axial length, on the other hand, the connection lines 39 (FIG. 3), which extend between the first ultrasonic transducer 35 and the second ultrasonic transducer 37, extend obliquely to the passage axis 22, as can in particular be seen in FIG. 3. Starting from an alignment extending in parallel with the passage axis 2, the measurement planes are in particular tilted about respective perpendicular lines 41 of the reflectors 36, and indeed by tilt angles of equal magnitude in opposite directions. In the embodiment shown, the tilt angle amounts to approximately 29° in each case.

It can be seen from FIGS. 4 and 5 that the perpendicular lines 41 of the reflectors 36 each extend at right angles to the passage axis 22. However, as can be seen in FIG. 5, they are arranged offset from the passage axis 22. The perpendicular lines 41 of the reflectors 36 are in particular spaced apart by the same offset from the passage axis 22 in opposite directions. A surrounding region 45 of the passage axis 22 is omitted here. The reflection angle amounts to approximately 17° for both reflection measurement paths 31, 32.

As can be seen in FIGS. 3 and 4, the two second ultrasonic transducers 37 disposed downstream project into the outlet fastening region 21. In this respect, the cable passages 47 associated with the second ultrasonic transducers 37 are each guided between two bores 19 through the outlet fastening region 21. In other words, the axial installation space taken up by the ultrasonic measurement apparatus 29 overlaps in the axial direction with the outlet fastening region 21. The axial installation length of the measurement body 13 can thereby be reduced.

Since, due to the arrangement of the reflection measurement paths 31, 32, a relatively large region of the cross-section of the fluid passage 15 is covered in a technical measurement aspect, the ultrasonic measurement is particularly reliable. It has been shown that reliable and disturbance-tolerant measurements are even possible with a throughflow measurement system 11 in accordance with the invention when the inlet flange 16 and the outlet flange 17 are designed as suitable for high pressure and the measurement body 13 has a length that amounts to at most three times the diameter of the fluid passage 15.

In general, the ultrasonic measurement apparatus 29 could also comprise more than two reflection measurement paths 31, 32 or only one reflection measurement path. Furthermore, the flow conditioner 25 could also, for example, be designed with one stage, two stages, four stages or five stages. In addition, a measurement path could be provided that intersects the passage axis 22 as a center path. Furthermore, reflection measurement paths having different reflection angles and/or different tilt angles could be provided.

### REFERENCE NUMERAL LIST

11 throughflow measurement system
13 measurement body
15 fluid passage
16 inlet flange
17 outlet flange
19 bore
21 outlet fastening region
22 passage axis
25 flow conditioner
27 perforated plate
29 ultrasonic measurement apparatus
31 reflection measurement path
32 reflection measurement path
35 first ultrasonic transducer
36 reflector
37 second ultrasonic transducer
39 connection line
41 perpendicular line
45 surrounding region
47 cable passage

1. A throughflow measurement system for measuring a fluid throughflow in a high pressure line, comprising:
a measurement body that has an inlet flange, an outlet flange and a fluid passage, wherein the fluid passage extends between the inlet flange and the outlet flange and has a passage axis;
an ultrasonic measurement apparatus integrated into the measurement body; and
a flow conditioner arranged upstream of the ultrasonic measurement apparatus in the fluid passage,
wherein an arrangement of bores for fastening means is provided at the outlet flange and an axially extending outlet fastening region of the measurement body is defined by the length of the bores,
wherein the ultrasonic measurement apparatus has at least one reflection measurement path that is spanned by a first ultrasonic transducer, a reflector and a second ultrasonic transducer and that extends in a measurement plane through the fluid passage such that the second ultrasonic transducer is arranged downstream of the first ultrasonic transducer, wherein the second ultrasonic transducer disposed downstream is arranged in or projects into the outlet fastening region.

2. The throughflow measurement system in accordance with claim 1,
wherein the ultrasonic measurement apparatus comprises at least two reflection measurement paths, wherein each of the reflection measurement paths is spanned by a first ultrasonic transducer, a reflector and a second ultrasonic transducer and extends in a measurement plane through the fluid passage such that the second ultrasonic transducer is arranged downstream of the first ultrasonic transducer.

3. The throughflow measurement system in accordance with claim 2,
wherein, in one of the measurement planes, a connection line extending between the first ultrasonic transducer and the second ultrasonic transducer extends obliquely to the passage axis.

4. The throughflow measurement system in accordance with claim 3,
wherein the connection line extends obliquely to the passage axis in each of the measurement planes.

5. The throughflow measurement system in accordance with claim 2,
wherein at least one of the measurement planes is tilted about a perpendicular line of the associated reflector, starting from an alignment extending in parallel with the passage axis.

6. A throughflow measurement system in accordance with claim 5,
wherein the tilt angle has a magnitude of at least 5° and at most 60°.

7. The throughflow measurement system in accordance with claim 5,
wherein the measurement planes of the reflection measurement paths are tilted in opposite directions.

8. The throughflow measurement system in accordance with claim 7,
wherein the measurement planes of the reflection measurement paths are tilted by tilt angles of equal magnitude.

9. The throughflow measurement system in accordance with claim 5,
wherein the perpendicular line is arranged offset from the passage axis, viewed in a cross-sectional plane of the fluid passage.

10. The throughflow measurement system in accordance with claim 1,
wherein the measurement body has a length that amounts to at most three times the diameter of the fluid passage.

11. The throughflow measurement system in accordance with claim 1,
wherein the flow conditioner is designed with at least three stages.

12. The throughflow measurement system in accordance with claim 1,
wherein the flow conditioner has at least one hub body that is rotationally symmetrical with respect to the passage axis and that has an arched onflow region.

13. The throughflow measurement system in accordance with claim 1,
wherein the flow conditioner comprises at least one Spearman rectifier, a honeycomb body, an inner tube and/or a perforated plate.

14. The throughflow measurement system in accordance with claim 1,
wherein the reflection measurement path has a reflection angle of at least 5° and at most 45°.

15. The throughflow measurement system in accordance with claim 1,
wherein each reflection measurement path has a reflection angle of at least 5° and at most 45°.

16. The throughflow measurement system in accordance with claim 1,
wherein the reflection measurement path measurement path is arranged completely outside a surrounding region of the passage axis.

17. The throughflow measurement system in accordance with claim 1,
wherein the measurement body is produced from steel and/or is formed in one piece.

18. The throughflow measurement system in accordance with claim 1,
wherein the measurement body is adapted for a fluid pressure of at least 0.5 bar and/or at most 110 bar.

19. The throughflow measurement system in accordance with claim 1,
wherein at least eight bores for fastening means are provided at the outlet flange, said bores being arranged distributed around the fluid passage.

20. The throughflow measurement system in accordance with claim 1,
wherein at least eight bores for fastening means are at the inlet flange, said bores being arranged distributed around the fluid passage.
